(19) United States
(12) Patent Application Publication
(10) Pub. No.: US 2003/0051235 A1
(43) Pub. Date: Mar. 13, 2003

(54) Method and apparatus for verifying and analyzing computer software installation

(76) Inventor: Mark D. Simpson, Ruckersville, VA (US)

Correspondence Address: John S. Beulick, Armstrong Teasdale LLP, Suite 2600, One Metropolitan Sq., St. Louis, MO, 63102, US

(21) Appl. No.: 09/948,899

(22) Filed: Sep. 7, 2001

(51) Int. Cl. G06F 9/445; G06F 9/44

(52) U.S. Cl. 717/174; 717/170

(57) ABSTRACT

A method for verifying and analyzing the installation of software onto a programmable device includes generating at least one installation data file containing information corresponding to at least one software file required for proper installation of the software, and comparing the information contained in the at least one installation data file with data pertaining to actually installed files on the programmable device to determine if the software is properly installed.

### BACKGROUND OF THE INVENTION

This invention relates generally to programmable microprocessor-based devices and, more particularly, to systems for ensuring proper installation of software programs for programmable devices.

Improper and/or incomplete installation of software programs in programmable devices causes unintended and undesirable operational errors. For example, improperly and/or incompletely installed software updates or upgrades to existing software programs can result in conflicting files that prevent proper software execution, which, in turn, can negatively affect the programmable device. Further, incomplete software installation results in the absence of needed program directories or files that can prevent the software from executing at all, thereby rendering the programmable device effectively useless.

Typically, software installation issues are resolved by troubleshooting phone or email conversations between software vendors and users. Unfortunately, however, results of this troubleshooting correspondence vary widely depending upon the parties to the correspondence and are not typically recorded for the benefit of resolving future software issues. Additionally, troubleshooting correspondence is often time intensive, and at least sometimes is complicated by miscommunication between vendors and users that can extend resolution of correctly identified problems because the user may not understand the directions provided by a vendor, or the vendor may not understand information and feedback provided by the user. For at least these reasons, results of troubleshooting correspondence are inconsistent, and successful resolution of software issues is difficult to reproduce.

While software installation issues are troublesome for computing devices in general, for some programmable devices, such as programmable logic controllers used to control a wide range of industrial equipment and devices, software issues can be even more problematic. Control schemes of such programmable logic controllers can become quite complicated, especially as the number of input/output devices increases in expandable systems. Accordingly, software management for controlling the various devices and making control decisions can become extensive.

Programming application software has been developed that allow users to create application-specific folders and programs that are, in turn, installed in a central processing unit of a programmable logic controller. As updated programming application software becomes available, and as additional input/output devices are introduced with new software provisions, troubleshooting software installation issues can become a challenging endeavor. Moreover, such programmable logic controller systems tend to run customized software, in addition to standardized software, for particular end use applications, making it even more problematic for software vendors to diagnose software installation issues. Of course, software installation defects can compromise the ability of the programmable logic controller to function effectively, thereby creating less than desirable operating conditions. When used, for example, in controlling manufacturing equipment, software installation defects and associated software debugging can result in manufacturing delay, lost productivity, and economic harm to a manufacturer. Also, undetected software installation issues can result in damaged controlled devices when the programmable logic controller system fails to control a device appropriately.

### BRIEF DESCRIPTION OF THE INVENTION

In one aspect, a method for verifying and analyzing the installation of software onto a programmable device is provided. The method comprises generating at least one installation data file containing information corresponding to at least one software file required for proper installation of the software, and comparing the information contained in the at least one installation data file with data pertaining to actually installed files on the programmable device to determine if the software is properly installed.

In another aspect, a programmable logic controller (PLC) system for software having at least one installation data file is provided. The PLC comprises a central processing unit (CPU), at least one input/output (I/O) module, a memory, at least one software file stored in said memory, at least one actually installed program data file containing information about said at least one software file, and said CPU configured to compare the information contained in said actually installed program data file with corresponding data in the at least one software installation data file to determine if said software file is properly installed in said memory.

In still another aspect, a programmable device is provided that is programmed to generate at least one installation data file containing the location, date and size of at least one software file required for proper installation of the at least one software file onto a microprocessor-based system, compare the at least one installation data file with the actual location, date and size of the at least one software file on the microprocessor-based system to determine if the at least one software file is properly installed on the microprocessor based system, and generate at least one log file containing the results of said comparison of the at least one data installation file with the actual location, date and size of the at least one software file on the microprocessor system.

### BRIEF DESCRIPTION OF THE DRAWINGS

FIG. 1 is flowchart illustrating process steps for verifying and analyzing installation of software programs onto a microprocessor-based programmable device.

FIG. 2 is a schematic block diagram of an exemplary programmable device for which the method shown in FIG. 1 may be employed.

### DETAILED DESCRIPTION OF THE INVENTION

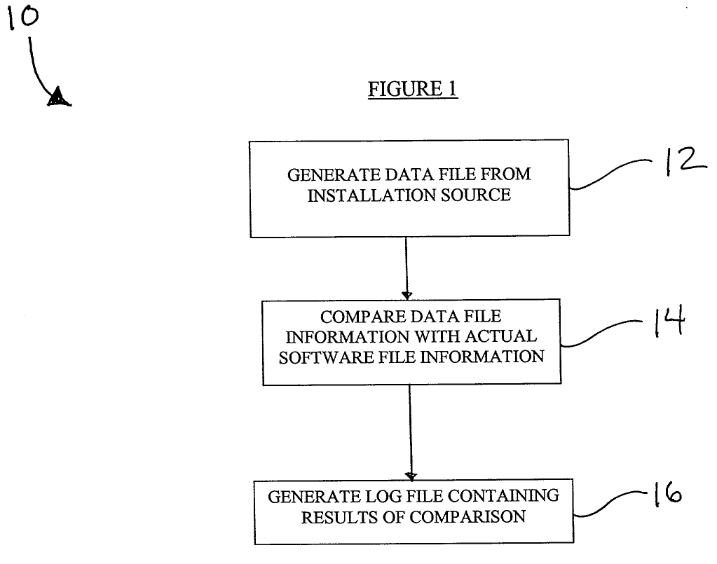

FIG. 1 is a flowchart 10 illustrating process steps for verifying and analyzing proper installation of software programs onto a microprocessor-based programmable device or system (not shown in FIG. 1). As used herein, “software” collectively refers to necessary files of a single program, which may be voluminous depending upon the program, as well as a plurality of programs desired on the subject programmable device. Typically, the software contains a plurality of files including program files and associated data files, together with other files appreciated by those in the art that may be required for certain programs. Also as used herein, the term programmable device refers to any microprocessor-based system including systems using microcontrollers, reduced instruction set circuits (RISC), application specific integrated circuits (ASICs), logic circuits, and any other circuit or processor capable of executing program software loaded thereto from an external source.

In an exemplary embodiment, and as illustrated in flowchart 10, prior to installation of desired software, an installation data file is generated 12 for a software installation source (not shown in FIG. 1), such as, for example, a CD-ROM, a personal computer, a computer server, or another programmable device. In a further embodiment, multiple installation data files are generated 12, although it is appreciated that the benefits of the present invention may accrue in the absence of a plurality of installation data files. In other words, the benefits of the invention may be appreciated with a single installation data file. Each installation data file that is generated 12 contains information relating to software files that represents the proper software structure intended to be installed on the programmable device. As such, by ensuring the correct software structure is contained in the installation source through verification of the installation data file, it can be insured that the associated software structure is correctly installed on the programmable device or devices.

In one embodiment, the data installation file relates to programming application software that allows users to create folders and programs for installation into a central processing unit of a programmable logic controller. It is understood, however, that the data installation file may relate to any other type of software, and consequently any intention to restrict the invention to any particular type or application of software is expressly disavowed.

In an illustrative embodiment, information contained in an installation data file may include, but is not limited to, file names, designated file locations, file dates, file sizes and file versions that are required for proper installation of the subject software. However, it will be understood that in alternative embodiments installation data files may be generated 12 that include other software file information relevant to successful software installation. An exemplary installation data file in accordance with the present invention for a specific application is provided in Appendix A, and includes file location, file name, file date and file size.

In an alternative embodiment, applicable installation data files may likewise be generated 12 for the installation source after the software is installed on the programmable device. In any event, the applicable software is loaded from the installation source to the programmable device, and is therefore installed or otherwise placed in selected locations in the programmable device according to known methods and techniques. As explained further below, in accordance with an exemplary embodiment of the invention, and during installation of the software, records are maintained as to software program files, data files, etc. that are actually installed on the installation source, and therefore that are transferred to the programmable device from the installation source during the installation process.

Once installation data files are generated 12, information contained in applicable installation data files is compared 14 with information relating to software files actually installed on or contained in installation source. By comparing 14 installation data files to actually installed file data, it may be verified that software files are properly located on the installation source for transfer to the programmable device and the files have, for example, the correct date, version and size. While comparing 14 the installation data files generated 12 for the installation source with actually installed program and file data, an error log may be generated 16 to identify potential or actual software installation issues and conflicts that may compromise proper execution of the software. Once errors are detected and the log file generated 16 by comparing 14 installation data files to actually installed file data, identified software installation issues may be corrected using the error log in a straightforward manner, thereby eliminating inconsistent, time intensive, trial and error correspondence between software vendors and software users that neither easily identifies or resolves software installation issues.

In addition, by identifying installation issues in the software source, it is generally unnecessary to individually verify software file installation on each of the programmable devices. It is contemplated, however, that the principles set forth herein could be equally employed to directly check and verify software file installation of each of the programmable devices.

In one embodiment, a separate software program, hereinafter referred to as a “system checker program” is used to compare 14 installation file data generated 12 by the installation source with actually installed file data and generate 16 the installation error log. In a further embodiment, when a system checker program is used, installation data files that are generated 12 for the software installation source are stored on the installation source prior to installation of the software. Once the software is actually installed, information relating to actually installed files (including pre-existing files before the subject software installation) may be located in target directories on the programmable device, i.e., directories of the programmable device wherein respective executable files of the software are located. However, data relating to actually installed files may alternatively be stored in other locations (locally or remotely to the programmable device) prior to comparison 14 of the installation data file generated 12 from the installation source with actually installed file data. For example actually installed file data may be located in other user-specified directories on the installation source programmable device or on an external disk, for example, a floppy disk or an external hard drive associated with the programmable device or the installation source. Once located, the system checker program then compares 14 the actual installed file data with information contained in installation data files generated 12 for the installation source and, based upon the comparison 14 generates 16 a log file, or log files, to indicate the results of comparison 14 The results of comparison 14 contained in the generated 16 log files can then be used to determine if the software has been properly installed. An exemplary log file generated 16 for specific software installation is provided in Appendix B.

In an illustrative embodiment, the log files generated 16 after comparing 14 installation data files to actually installed file data include WARNING, ERROR, and INFO messages. WARNING messages indicate a discrepancy, between the actual file information, as determined by actually installed file data, and desired file information, as determined by the installation data files, that may or may not cause an error in software operation. For example, a file actually present on the programmable device having a newer date than the corresponding file date contained in the installation data file typically will not cause operational problems with the software. However, the WARNING message serves to notify the software user of the discrepancy. ERROR messages indicate discrepancies that will likely cause operational problems with the software or the programmable device. For example, a file actually present on the programmable device having an older date than the corresponding file date contained in an installation data file will likely cause the software to malfunction. INFO messages present information that may help explain WARNING and/or ERROR messages. Additionally, in one embodiment, log files generated 16 from comparing 14 installation data files with actually installed file data also include definitions of components of the programmable device that are derived from information on the programmable device itself. It is contemplated that other useful information may be provided in the error log in addition to or, even in lieu of, the above-described messages without departing from the scope of the present invention.

In one embodiment, the system checker program includes options designed to facilitate use of the system checker program and allow users to customize the operation of the system checker program. For example, in an exemplary embodiment, the system checker program includes a help option. The help option may include, but is not limited to, the version of the system checker program and descriptions of the purpose and operation of other options included in the system checker program. In another embodiment, the system checker program includes a directory option. The directory option indicates the location of the actual installation data file used for comparing 14 actually installed file data to installation file data generated 12 from the installation source, ultimately to generate 16 the error log. For example, the directory option may indicate that the actual installation data file is located in the programmable device target directory, a directory on the programmable device other than the target directory, or an external disk.

In another embodiment, the system checker program includes a verbose option. When the verbose option is active, the log file includes INFO messages describing all of the file comparisons made by the system checker program. When the verbose option is inactive, the generated 16 log file only includes INFO messages that describe WARNING or ERROR messages present in the log file. The log file provided in Appendix B, for example, was generated with the verbose option activated and, consequently, the log file provided in Appendix B includes INFO messages describing all comparisons made by the system checker program.

In still another embodiment, the system checker program includes a speed-up option. When the speed-up option is active, the system checker does not compare the software file versions on the programmable device with the file versions contained in the installation data file. File version comparison is a time-consuming process, and therefore skipping the file version comparison speeds up the operation of the system checker program, and therefore generates 16 the log file in less time than when file version comparison is included when comparing 14 installation data files generated 12 for the software installation source to actually installed file data.

It is believed that programming of the above-described system checker program is within the purview of those in the art without detailed explanation of routines and subroutines of the system checker program. In addition, it is recognized that other features could be provided in the system checker software program beyond the basic features described above without departing from the scope of the present invention. It is further understood that the above-described methodology could be employed equally with a wide variety of programmable devices to identify and resolve software installation issues. In addition, it is recognized that, in lieu of the above-described system checker program, the comparison to generate 16 the log may be performed with a known computer-readable medium in conjunction with computer-executable instructions.

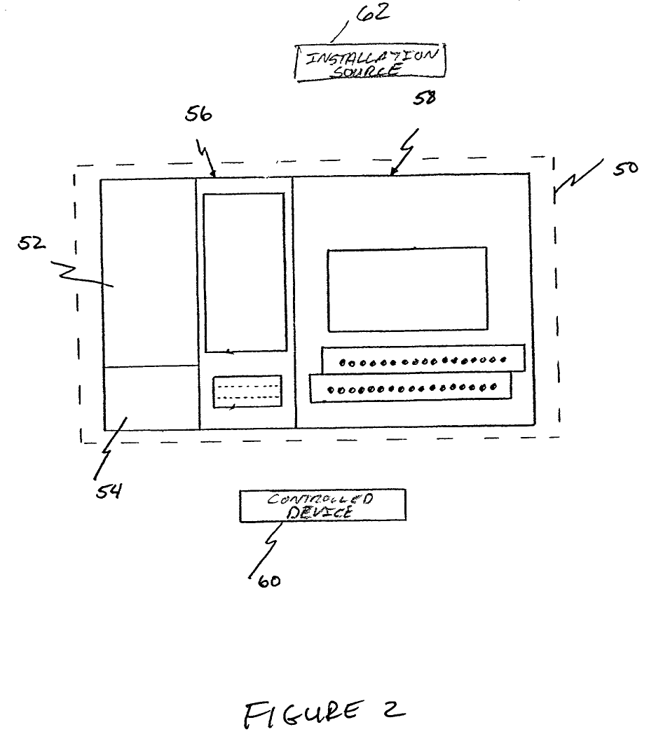

FIG. 2 is a block diagram of one type of programmable device, and more specifically, a programmable logic controller (PLC) 50, for which the above-described process 10 has found particular use. Programmable logic controller 50 includes a central processing unit (CPU) 52, a memory 54 associated with the processor, a first Input/Output (I/O) unit 56, and a second I/O unit 58. Although I/O units 56 and 58 are shown in FIG. 2, in alternative embodiments, programmable logic controller 50 may include only one I/O unit, for example, an I/O unit for interfacing to a single device such as a motor (not shown), or an I/O unit for receiving various input signals from multiple devices, i.e., a plurality of switches (not shown). In addition, programmable logic controller 50 may include a number of additional I/O units 56 and/or I/O units 58 for interacting with other remote devices. Units 56 and 58, in operation, typically are coupled to one or more controlled external devices, such as, device 60.

Control software is loaded from an installation source 62 and is stored in memory 54. In one embodiment, control software is programming application software that enables users to create application specific folders and files to control operation of CPU 52. When loaded into memory 54, programmable logic controller 50 is controlled so that, based at least in part on inputs from device 60 and units 56 and 58, appropriate outputs to controlled device 60 in response to input from units 56 and 58 are generated. The control software is typically stored on installation source 62 and transferred to memory 54 as multiple program files. Specifically, in one embodiment control and data signals (not shown) are bi-directionally coupled between CPU 52 and units 56 and 58. The signals are utilized to exchange information between CPU 52 devices 56 and 58. Information is exchanged between units 56 and 58 and device 60 using various known transmission mediums, for example individual wires and multiple conductor cables in a particular exemplary embodiment. In addition, certain devices typically have integrated wires or cables to be coupled to I/O units 56 and 58.

It is believed that the construction and operation of programmable logic controllers are appreciated by those in the art without further explanation. It will further be appreciated that the control schemes of such programmable logic controllers can become quite complicated, especially as the number of input/output devices increases in expandable modular PLC systems. Accordingly, software management for controlling the various devices and making control decisions can become extensive.

As updated software, such as application programming software loaded to memory 54 from installation source 52 becomes available, and as additional input/output devices 56, 58 are introduced with new software provisions, troubleshooting software installation issues can become a challenging endeavor. Moreover, programmable logic controller systems, such as system 50, tend to run customized software, in addition to standardized software, for particular applications, making it even more problematic for software vendors to diagnose software installation issues. Of course, software installation defects can compromise the ability of the programmable logic controller to function effectively, thereby creating less than desirable operating conditions. When used, for example, in controlling manufacturing equipment and devices, software installation defects and associated software debugging can result in manufacturing delay, lost productivity, and economic harm to a manufacturer. Undetected software installation issues can also result in damaged controlled devices when the programmable logic controller system fails to control the device appropriately.

Therefore, in accordance with the present invention, installation source 62 and/or programmable logic controller 50 includes at least one actually installed program data file (not shown) containing control software installation that may be employed in process 10 (shown in FIG. 1) to diagnose and address control software installation issues as additional control software is introduced and/or existing software is updated.

A CPU (not shown in FIG. 2), such as a CPU associated with installation source 62, is configured to compare 14 (shown in FIG. 1) the information contained in a data installation file (described above in relation to FIG. 1) with the actually installed file data information (also described above in relation to FIG. 1), such as with the above-described system checker program. By comparing installation data file information to actually installed file data, it may be verified that the applicable control software files are completely installed on installation source 62 and ready for transfer to memory 54, and further to verify that control software files have the correct date, version and size The CPU then generates 16 (shown in FIG. 1) an error log file (as described above in relation to FIG. 1), or error log files, to indicate the results of the comparison. The results of the comparison contained in the log files can then be used to determine if the applicable control software has been properly installed. The CPU, in different embodiment, may be CPU 54, a CPU associated with installation source 62, or an external CPU of another programmable device.

Once the error log is generated 16, software discrepancies and installation issues are clearly identified for focused attention to resolve them. As such, software installation issues are efficiently and automatically identified as software is introduced to installation source, and accordingly software defects may be efficiently redressed to ensure proper operation of programmable logic controller 50. Costly manufacturing delays and time intensive troubleshooting correspondence due to improperly installed software is therefore eliminated, together with associated costs

While the invention has been described in terms of various specific embodiments, those skilled in the art will recognize that the invention can be practiced with modification within the spirit and scope of the claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for verifying and analyzing the installation of software onto a programmable device, said method comprising:
generating at least one installation data file containing information corresponding to at least one software file required for proper installation of the software; and
comparing the information contained in the at least one installation data file with data pertaining to actually installed files on the programmable device to determine if the software is properly installed.

2. A method in accordance with claim 1 wherein the information contained in the at least one installation data file includes a designated location of the at least one software file required for proper installation of the software, said comparing the information contained in the at least one data installation data file with the data pertaining to actually installed files on the programmable device further comprises comparing the designated location of the data installation file with location data of the actually installed file on the programmable device.

3. A method in accordance with claim 1 wherein the information contained in the at least one installation data file includes the date of the at least one software file required for proper installation of the software, said comparing the information contained in the at least one data installation data file with data pertaining to actually installed files further comprises comparing the date of the at least one software file required for proper installation of the software with date data of the at least one actually installed file to determine if the software is properly installed.

4. A method in accordance with claim 1 wherein the information contained in the at least one installation data file includes the size of the at least one software file required for proper installation of the software, said comparing the information contained in the at least one data installation file with data pertaining to actually installed files further comprises comparing the size of the at least one software file required for proper installation of the software with size data of the at least one actually installed file to determine if the software is properly installed.

5. A method in accordance with claim 1 wherein the information contained in the at least one installation data file includes the version of the at least one software file required for proper installation of the software, said comparing the information contained in the at least one installation data file with data pertaining to actually installed files further comprises comparing the version of the at least one software file required for proper installation of the software with version data of the at least one actual installed file to determine if the software is properly installed.

6. A method in accordance with claim 1 wherein the programmable device comprises an installation source.

7. A method in accordance with claim 1 further comprising generating at least one log file containing the results of comparing the information contained in the at least one data installation file with data pertaining to actually installed files to determine if the software is properly installed.

8. A method in accordance with claim 7 wherein generating the at least one log file comprises documenting results of all file comparisons made while comparing the information contained in the at least one data installation file with data pertaining to actually installed files.

9. A method in accordance with claim 7 wherein generating the at least one log file comprises documenting only file discrepancies determined while comparing the information contained in the at least one data installation file with data pertaining to actually installed files.

10. A programmable logic controller (PLC) system for software having at least one installation data file, said PLC system comprising:
a central processing unit (CPU);
at least one input/output (I/O) module;
a memory;
a software installation source comprising at least one actually installed software file for loading into said memory;
at least software installation file containing information about said at least one actually installed software file; and
at least one software installation log generated by comparing the information contained in said actually installed program data file with corresponding data in said at least one software installation data file to determine if said software file is properly installed in said memory.

11. A PLC system in accordance with claim 10 wherein the at least one data installation file includes a designated location of said at least one software file stored in said memory, said actually installed program file comprising location data of said at least one software file stored in said memory, said log comprising a comparison of the designated location of with said location data to determine if said at least one software file is properly installed.

12. A PLC system in accordance with claim 10 wherein the at least one installation data file includes a designated date of said at least one software file stored in said memory, said actually installed program file comprising date data of said at least one software file stored in said memory, said log comprising a comparison of the designated date with said date data to determine if said at least one software file is properly installed.

13. A PLC system in accordance with claim 10 wherein the at least one installation data file includes a designated size of said at least one software file stored in said memory, said actually installed program file comprising size data of said at least one software file stored in said memory, said log comprising a comparison of the designated size with said size data to determine if said at least one software file is properly installed.

14. A PLC system in accordance with claim 10 wherein the at least one installation data file includes a designated version of said at least one software file stored in said memory, said actually installed program file comprising version data of said at least one software file stored in said memory, said log comprising a comparison of the designated version with said version data to determine if said at least one software file is properly installed.

15. A PLC system in accordance with claim 10 wherein said system comprises a CPU configured to generate said at least one log file containing the results of comparing the information contained in said actually installed program data file with corresponding data in the at least one software installation data file to determine if said software file is properly installed in said memory.

16. A PLC system in accordance with claim 15 wherein said at least one log file comprises results of all file comparisons performed by said CPU.

17. A PLC system in accordance with claim 15 wherein said at least one log file comprises noted file discrepancies of all file comparisons performed by said CPU.

18. A PLC system in accordance with claim 15 wherein said CPU is configured to indicate the location of said at least one data actually installed program data file.

19. A programmable device programmed to:
generate at least one installation data file containing the location, date and size of at least one software file required for proper installation of the at least one software file onto a microprocessor-based system;
compare the at least one installation data file with the actual location, date and size of the at least one software file on the microprocessor-based system to determine if the at least one software file is properly installed on the microprocessor based system; and
generate at least one log file containing the results of said comparison of the at least one data installation file with the actual location, date and size of the at least one software file on the microprocessor system.

20. The programmable device of claim 19 wherein the at least one installation data file further includes a version of the at least one software file required for proper installation of the at least one software file and said programmable device is further programmed to compare the installation data file version with the actual version of the at least one software file on the microprocessor-based system.

21. The programmable device of claim 19 wherein the at least one log file includes the results of all file comparisons made in said computer comparison of the at least one data installation file with the actual location, date and size of the at least one software file.

22. The programmable device of claim 19 wherein the at least one log file includes only the results of file discrepancies determined in said computer comparison of the at least one data installation file with the actual location, date and size of the at least one software file.

23. The programmable device of claim 19 wherein said microprocessor based system comprises a software installation source.
